(19) United States
(12) Patent Application Publication
(10) Pub. No.: US 2006/0201622 A1
(43) Pub. Date: Sep. 14, 2006

(54) Method and device for attaching support sections for rubber seals to automobile body parts and corresponding support section

(76) Inventors: Ralf Sehr, Losheim am See (DE); Ralf Bickel, Beckingen (DE)

Correspondence Address: James C Wray, 1493 Chain Bridge Road, Suite 300, McLean, VA, 22101, US

(21) Appl. No.: 10/471,767

(22) PCT Filed: Mar. 26, 2002
(86) PCT No.: PCT/DE02/01102

§ 371 Date: Apr. 2, 2004

(30) Foreign Application Priority Data
Mar. 27, 2001 (DE) 101 15 091.1
Aug. 29, 2001 (DE) 101 42 288.1

(51) Int. Cl. C09J 5/00

(52) U.S. Cl. 156/324

(57) ABSTRACT

Methods, devices and support profiles are configured to match the method and device in profiles used to attach a support section for rubber seals to automobile body parts in the shortest possible time with the minimum of tools and personnel. The methods and devices are adaptable in such a way that modifications to the geometry of the sealing section and to the contours of the body parts are accommodated without long stoppages of the assembly line. The support sections and connecting regions mold to all the contours of automobile bodyworks, in particular corner regions, and permit the attachment of various sealing regions and application of extreme detachment forces. The support section for the sealing section is attached to the support surface in one single operation. The sub-steps of said operation are carried out by an industrial robot. Adhesive is applied to the support section during its production.

The present invention concerns methods and devices for attaching support sections for rubber seals to automobile body parts as well as self-adherent support sections which are particularly suited for attachment using these methods and devices. Furthermore, the invention includes a connection region which is allocated to one of these support sections and by means of which the sealing region of the rubber seal is inserted onto the support section.

In manufacturing automobiles, not attaching seals which protect the passenger interior space or the trunk in the region of doors and trunk seals from moisture penetrating directly to the supporting surface, thus to the sheet metal part, namely the door or the trunk seal, but rather first fastening the support section on the support surface and then installing the sealing section thereupon is to be viewed as advantageous.

Sealing sections on doors and trunk seals are subject to wear and tear or can lose their function through damage. For this reason, it is important that the sealing sections can be changed without great expense and without damaging the support surface. Therefore, it is advantageous to position the sealing section on a support section and to join the support section fast with the support surface, for example the door body, for example by gluing. Normally only the sealing section will fail and the support section can be further used. The sealing section can then be removed from the support section and be replaced by a new one. The support surface is not damaged by this process, and no special tools, adhesives or other expensive technologies are needed for exchange of the sealing section.

Moreover, a support section can be used for positioning various types of seal shapes or seal sizes. In changing or in variants of the automobile model which are associated with a change in the form or length of the sealing section, the same support section and the same connection area can still be used in certain limits. It is possible to react to different shaped or different size slits which are to be sealed off by adapting the size of the sealing region of the sealing section while retaining the connection region and the support section.

These advantages particularly come to bear when the support section and the sealing section can be used as yard good, since the required length can then be very rapidly attained by simple cutting.

Such an arrangement for a movable connection of at least two subassemblies using plug connections, for example for joining a sealing section with a motor vehicle body, is known from DE 19808044 C2. Preferably here the floor subassembly (3) is fastened on the first subassembly (2) by tip-stretching. The tip-stretching can take place using a suitable casting technique.

Furthermore, DE 19802203 A1 describes a method for manufacturing a connection of a subassembly with a component. Here an intermediate holder of hardened casting compound is introduced between subassembly (2) and component (1). In this way, a detachable connection between component and subassembly is produced through the intermediate holder. To reinforce this connection, the intermediate holder can be cemented to the component since the casting compound is placed in a coat of adhesive. A retaining apparatus serves to fix the subassembly in place which fixes the position of the subassembly and component in place until the casting compound introduced between subassembly and component hardens to an intermediate support connecting these elements with each other.

DE 19714242 A1 describes a similar method. Here an adhesive is applied to the first subassembly. A connection element is placed upon this, and thereupon a second subassembly is installed, preferably clipped on. According to a further refinement of the invention, casting compound can be put into the first subassembly through perforations. The casting compound should embrace or reach behind the profiling of the connection piece so that in this way the connection element is held fast on the first subassembly. In industrial use, the connection piece is inserted into a retaining device and pressed against the connection region provided with a glue and held so long after administering the casting compound until the casting compound is hardened.

The use of a casting compound to be applied in the form of a liquid during assembly nonetheless leads to the hollow space into which the casting compound is to be introduced, for example the space between door body and sealing, having to be sealed against an undesired exit of casting compound which is associated with a great expense. On the other hand, openings must be created in the door body, for example in the form of bore holes, through which the casting compound can be introduced into the hollow space. These bore holes nonetheless reduce the strength of the carriage, are susceptible to corrosion, and the manufacture of the bore holes represents an additional operation in assembling the automobile.

DE 3808443 A1 describes a process and a device for implementing the method with which final contours can be applied fully automatically to support elements, especially to motor vehicle doors. The final seal is readied on a retaining device. The robot accommodates the door in a magazine and moves it to the retaining device. Here first one end of the seal is glued on the fastening surface of the door. Thereupon the robot moves the door with the sealing to a pressing device. The complete seal is now fastened on the fastening surface by rolling the door and pressing the seal. Gluing the seal in accordance with this method requires much equipment: Industrial robots with grasping apparatus and a subassembly place consisting of a retaining device, pressing apparatus, positioning apparatus and gluing station. The number and the interplay of these devices bring about an extremely complicated and time-consuming sequence subject to disturbances. Many of the devices used here, for example the retaining device, are adapted to the shape of the seal to be applied. If the shape of the seal changes, these parts must likewise be altered.

The use of retaining apparatus or retaining devices leads to further disadvantages. The retaining device adjusted to the seal or support section and especially to the contour of the door. Changes in shape of these parts therefore lead to an inability to use the retaining device any more. It must be adapted to the new shape. One therefore also needs an independently designed retaining device for each model variant. High investment costs as well as high equipment expenditures in converting between different model variants is the consequence.

U.S. Pat. No. 4,620,354 describes a method for using a robot to apply a seal (10) to a flange (12 or 13) which runs around the opening of an automobile body (8), The seal is pulled out of a storage device (20) and pressed upon the flange beginning with a starting position. After reaching an end position, the robot conducts the seal to a cutting apparatus (58) which cuts off the seal such that the ends of the strand are adjacent to each other. A joining compound can be applied to the end of the sealing strand using the cutting apparatus or another apparatus.

Proceeding from this, the basis of the invention is the objective of developing a device, a method as well as support sections and connection regions adapted to the method and the device with the aid of which applying a support section for sealing contours to automobile body parts succeeds in the shortest time possible with low expenditure of tools and personnel. Furthermore, the method and the device should be adaptable such that it is possible to react to changes in the shape of the rubber seal and especially in the contour of the body parts without long stoppages of the assembly lines. The support sections and connection regions must be able to follow the course of the automobile body on doors and trunk seals even in corner regions, and must make possible applying different sealing regions and high withdrawal forces.

The objective is accomplished in that applying the support section to the support surface takes place consisting of one operation of a rapid sequence of sub-steps staggered temporally only shortly in relation to one another. The sub-steps are conducted by an industrial robot. The motions of the robot are programmed following the geometrical contour of the support surface, thus of the door body or the trunk seal. Upon changing or varying the automobile model, it is possible to react correspondingly by reprogramming the motions of the robot rapidly, that is without longer interruptions of production and without extensive change of the assembly tools, and in this way without great costs. After positioning the support section, the seal section proper can be installed.

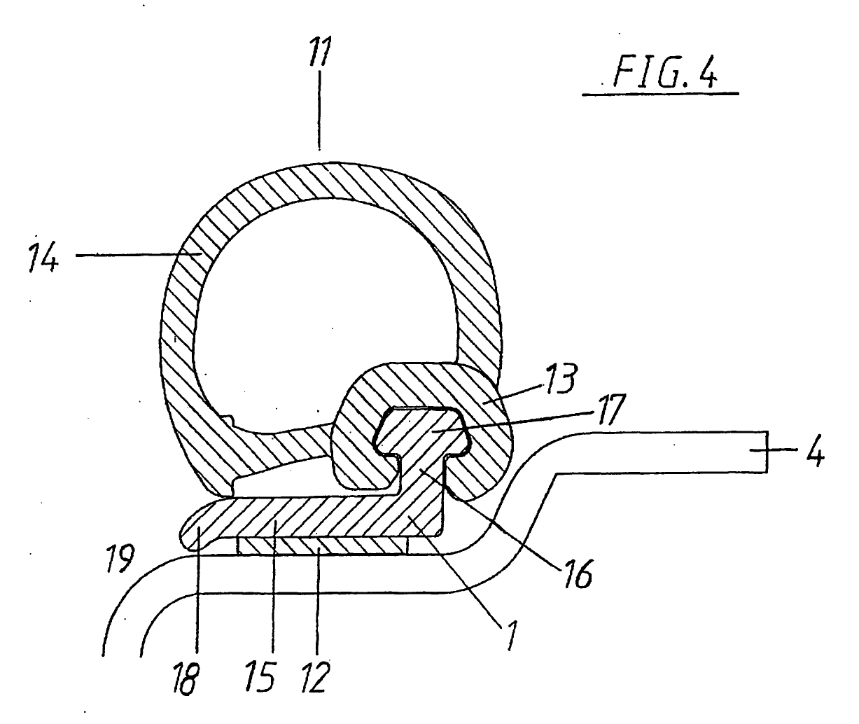

The support sections and the connection regions are suitable for applying various types of sealing regions onto an automobile body, be it a tube-like sealing region of soft rubber or a lip seal as represented in FIG. 4. The sealing region can consequently be adapted to various uses as a function of slit width and shape while retaining the support section and connection region.

In an advantageous refinement of the invention, the support section is provided with an adhesive system already during its manufacture. The adhesive system is first applied immediately before applying the support section to the support surface using an activation unit for action. Triggering the reaction of the adhesive system can take place by administering ultraviolet or infrared radiation, for example. This method has the advantage that during assembly, where it is of considerable significance to save time and to have as few disturbances as possible in the sequence of the method. no adhesive system need be applied.

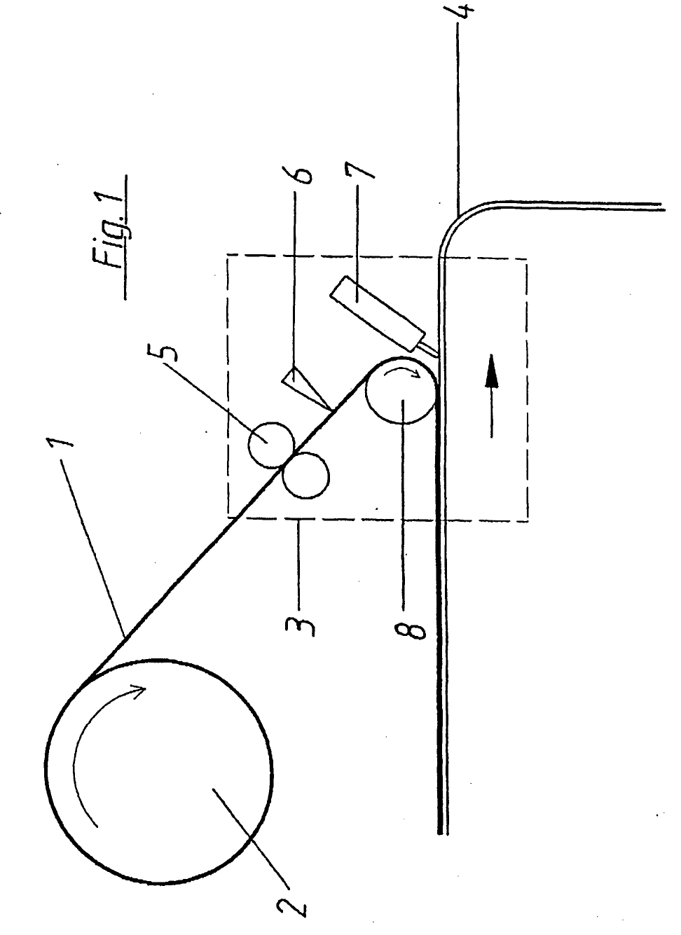

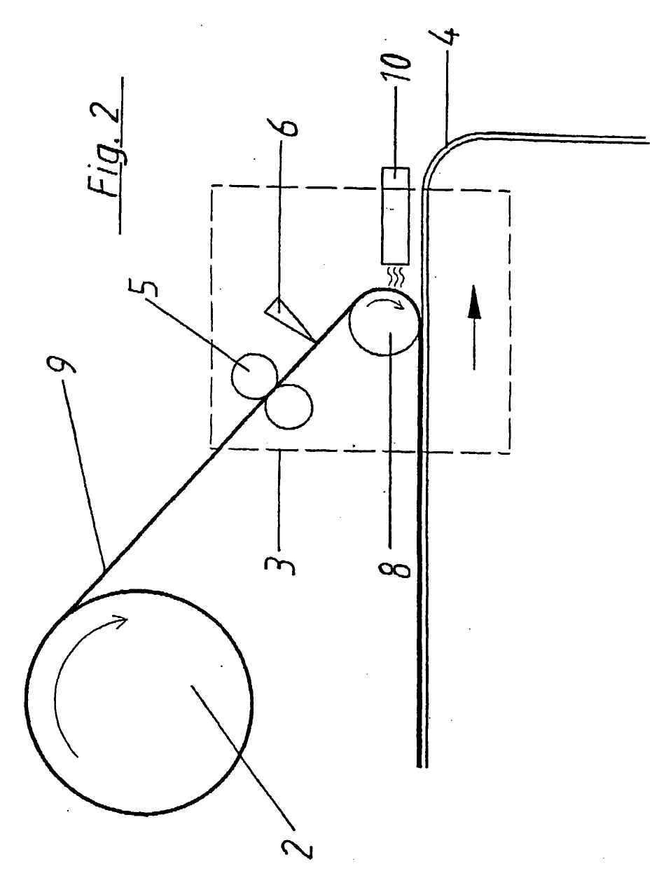

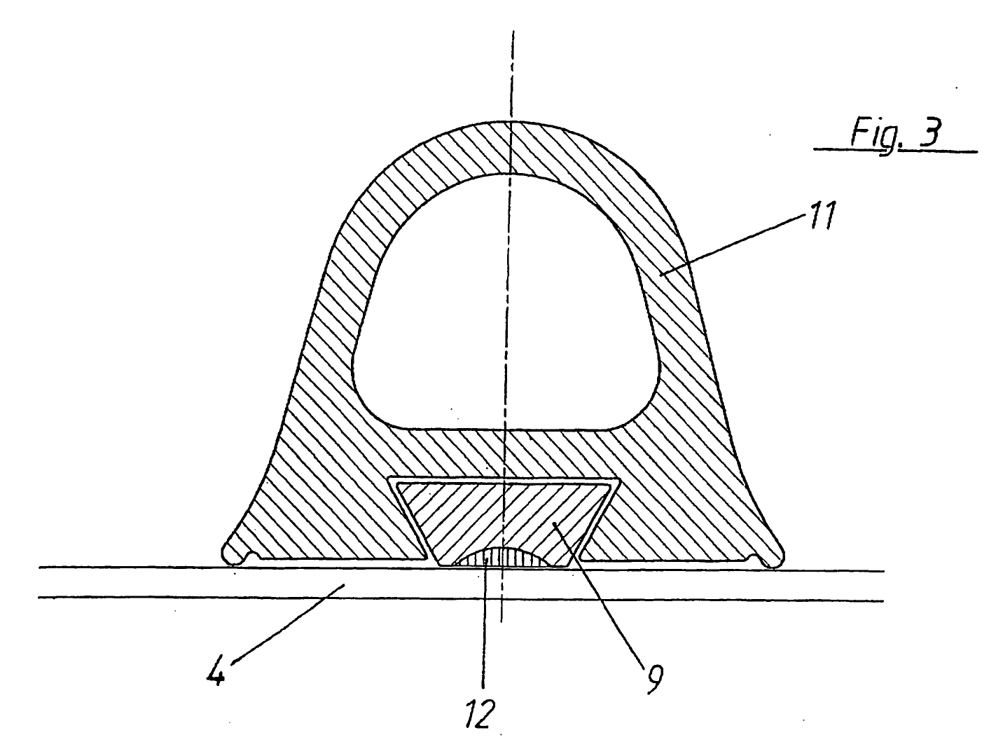

The invention is represented on the basis of two embodiments for method and device in FIGS. 1 and 2. FIGS. 3 and 4 show respectively a support section with a sealing section. Method, device, support sections and connection regions are described below with reference to the Figures.

FIG. 1 illustrates a method and a device by means of which the adhesive system is applied directly before positioning the support section 1 onto support surface 4. The support section is rolled up on a drum-like storage device 2. The support section is withdrawn from the storage device by a movable application apparatus 3 and glued on a support section 4, for example a door body or a trunk seal. The motions of the application apparatus are programmed following the contour of the support surface. The application apparatus, constructed as an industrial robot, consists of guide rollers 5 which guide the support section after emerging from the storage device following the motions of the application apparatus, a path-controlled cutting unit 6 by means of which the support section is cut after reaching a final length, for example after applying the support section over the complete periphery of a door, a coat of adhesive 7 by means of which the adhesive system is applied to the support surface and pressing and guide rollers 8 which guide the support section and press it into the adhesive system.

FIG. 2 shows a method and a device by means of which a self-adhering support section 9 is positioned on a support surface. The difference from the process or device described in FIG. 1 consists in that the support section 9 rolled up on the storage device 2 was already provided with an adhesive system when manufactured. The application apparatus 3 likewise contains guide rollers 5, a path-controlled cutting unit 6 as well as pressing and guide rollers 8. This application unit is rather provided with an activation unit 10 instead of a coat of adhesive. This brings the reaction of the adhesive system on the side of the support section facing the support surface into motion in that it administers ultraviolet or infrared radiation or pressure, for example, before the support section is pressed upon the support surface 4 by the pressing and guide rollers.

FIG. 3 illustrates a self-adherent support section 9 with installed sealing section 11 which can be especially advantageously applied to a support surface according to the method represented in FIG. 2 or with the device represented in FIG. 2. The geometrical shape of the support section was selected to be able to position the sealing section simply on the support section and to be able to detach it from the latter. A gutter-like groove is worked into the support section on the side facing the support surface into which the adhesive system 12 was already applied during manufacture.

FIG. 4 illustrates a support section 1 with a sealing section 11 which is divided into a connection region 13 and a sealing region 14. In this example, the sealing region is constructed tube-like consisting of soft rubber. In other applications of the invention, however, it can also be constructed as a lip seal or in another shape adapted to the application. In the tube-like construction, the diameter of the sealing region can be selected as a function of the size of the slit to be sealed off. The sealing region occupies a much greater space in the application selected in relation to the connection region joined, for example, glued with it, so that the space to be sealed off is filled up as best as possible.

Therefore, the seal is also made of soft rubber in the application, while the connection region of the sealing section and the support section are made of a harder material. Moreover, the material of the connection region and support section are, however, to be selected such that both subassemblies can flexibly follow the course of the automobile body even into corner regions. Furthermore, the material of which the support section is made must be adhesive-friendly and be resistant in the reaction with the adhesive system.

The support section can already be provided with an adhesive in the manufacturer's factory, thus be self-adherent, or the adhesive system can first be applied before positioning the support section on the support surface.

The support section 1 is constructed with a long, straight line segment 15 which runs in the region of the adhesion surface approximately parallel to the support surface 4 of the automobile body. The long, straight line form of the segment is chosen as a function of the width of the supporting surface in order to make available as large a surface as possible for the adhesion system 12 and in this way to attain as high a withdrawal force of the support section 1 on the support surface 4 possible.

Furthermore, the support section 1 is constructed with a retention peg 16 which points perpendicular to the segment 15 in the direction of the sealing section 11. The retention peg 16 ends in a trapezoidal slip-fit flange.

The connection region 13 of the sealing section 11 is positioned on the trapezoidal slip-fit flange 17 of the support section 1 and creates a form-locking connection owing to its C-shaped form which guarantees a high withdrawal force between connection region 13 and therewith the sealing section 11 and the support section 11 in interplay with a suitably hard but flexible material, such as, for example, hard rubber.

As an advantageous construction of the invention, the segment 15 of the support section 1 on the side opposite the retention peg 16 is constructed with a lip which points toward the support surface 4 of the automobile body and optically covers over the adhesive system 12 toward the vehicle interior.

### REFERENCE NUMBER LIST

1 Support section
2 Storage device
3 Application apparatus
4 Support surface
5 Guide rollers
6 Cutting unit
7 Coat of adhesive
8 Pressing and guide rollers
9 Self-adherent support section
10 Activation unit
11 Sealing section
12 Adhesive system
13 Connection region
14 Sealing region
15 Segment
16 Retention pin
17 Slip-fit flange
18 Lip
19 Vehicle interior

1. Method for positioning support sections (1) for rubber seals (11) on support surfaces (4), such as, for example, door bodies and trunk seals of automobiles using an application apparatus (3) in the form of an industrial robot which follows the contour of the support surface (4), whereby the support section (1) is pulled out of a drum-like storage device (2) by the application apparatus (3), guided by the application apparatus using guide rollers (5) after leaving the storage device (2), cut after attaining its final length by a path-controlled cutting unit (6) in the application apparatus (3) and pressed by the application apparatus (3) upon the support surface (4) using pressing and guide rollers (8), wherein the support section (1) is brought into adhering connection to the support surface (4) by the application device (3).

2. Method according to claim 1, wherein the application apparatus (3) applies the adhesive system to the support surface (4) using a coat of adhesive (7).

3. Device for positioning support sections (1) for rubber seals (11) on support surfaces (4), such as, for example, door bodies and trunk seals of automobiles, consisting of a storage unit (2) on which the support section (1) is rolled up, of an application apparatus (3) which includes at least 2 guide rollers (5), a path-controlled cutting unit (6) as well as at least one pressing and guide roller (8), wherein the application apparatus (3) is constructed with a coat of adhesive (7).

4. Self-adherent support section (9) for sealing sections (11) on support surfaces (4), such as, for example, door bodies and trunk seals of automobiles, wherein a gutter-like groove is hollowed out on the side which is to be joined with the support surface into which an adhesive system (12) is applied already during the manufacture of the self-adherent support section whose adhesive action is nonetheless first set into motion upon positioning the self-adherent support section on the support surface.

5. Method according to claim 1, wherein the application apparatus (3) sets the adhesive action of the adhesive system (12) into motion on the self-adherent support section (9) using an activation unit (10).

6. Device for applying self-adherent support sections (9) for rubber seals (11) on support surfaces (4), such as, for example, door bodies and trunk seals of automobiles, consisting of a storage device (2) on which the self-adherent support section (9) is rolled up, and of an application apparatus (3) which includes at least 2 guide rollers (5), a path-controlled cutting unit (6) as well as at least one pressing and guide roller (8), wherein the application apparatus (3) is constructed with an activation unit (10).

7. Support section (1) and connection region (13) for fastening sealing sections (11) to support surfaces (4) of automobile bodies, wherein the support section (1) is constructed in the form of a long, straight line segment (15) which is positioned on the support surface (4) using an adhesive system (12) and which runs somewhat parallel to the support surface (4) of the automobile body in the region of the adhesive surface, wherein the support section (1) has a retention peg (16) which points in the direction of the sealing section (11) and ends in a trapezoidal slip-fit flange (17), wherein the connection region (13) is constructed C-shaped and embraces the trapezoidal slip-fit flange (17) form-locking, wherein the connection region (13) is connected with the sealing region (140 of the sealing section (11).

8. Support section (1) according to claim 8, wherein the end of the segment (15) which lies opposite the retention peg (16) is constructed as a lip (18) which points toward the support surface (4) of the automobile body.

9. Support section (1) according to claim 8, wherein the surface of the segment (15) pointing toward the support surface (4) of the automobile body has an adhesive system (12) which was already applies at the manufacturer.
